(19) United States
(12) Patent Application Publication
(10) Pub. No.: US 2014/0189670 A1
(43) Pub. Date: Jul. 3, 2014

(54) SYSTEM AND METHOD FOR TAILORING APPLICATIONS AND APPLICATION REPOSITORIES FOR INDIVIDUAL ELECTRICAL DEVICES

(71) Applicant: OPENPEAK INC., Boca Raton, FL (US)

(72) Inventor: Timothy Clay, Lake Worth, FL (US)

(73) Assignee: OPENPEAK INC., Boca Raton, FL (US)

(21) Appl. No.: 13/731,821

(22) Filed: Dec. 31, 2012

(51) Int. Cl. G06F 9/445

(52) U.S. Cl. CPC G06F 8/65; G06F 8/60
USPC 717/168; 717/174

(57) ABSTRACT

Systems and methods are directed to tailoring applications for an electrical device. An electrical device can include a processor and a device performance module operatively connected to the processor. The device performance module can assess one or more performance capabilities of the electrical device. In one implementation, the device performance module can adjust an application based on one or more of the assessed performance capabilities of the electrical device. In another implementation, the device performance module can report the one or more assessed performance capabilities to an application repository. The electrical device can receive a list of suitable applications for the electrical device based on the one or more assessed performance capabilities from the application repository. In response to receiving the list, the device performance module can present at least a subset of suitable applications for the electrical device to a user.

### FIELD

Embodiments relate in general to electrical devices and, more particularly, to the tailoring of applications and application repositories for individual electrical devices.

### BACKGROUND

In recent years, the use of smart phones and tablet computers has proliferated throughout the industrialized world. Accompanying the market growth of these devices has been the use of online stores from which users can purchase and download applications for their devices. Each online store usually provides applications for a particular operating system, such as the Android™, Windows Phone® and iOS operating systems. However, the hardware on which the operating systems execute can vary significantly. For example, the Android™ operating system is used on smart phones and tablet computers manufactured by a plethora of different companies. Many of these companies customize Android™ for their particular devices, so the specific implementation of Android™ can vary from device to device.

### SUMMARY

In one respect, embodiments are directed to an electrical device. The electrical device can include a processor and memory operatively connected to the processor. The electrical device can include a device performance module, which can be stored on the memory. The device performance module is configured to assess one or more performance capabilities of the electrical device. The device performance module is also configured to adjust an application based on one or more of the assessed performance capabilities of the electrical device.

In one embodiment, the device performance module can perform the assessing one or more performance capabilities of the electrical device and the adjusting of the application when the application is initiated for execution on the electrical device. The application can be installed on the electrical device, or the application can be installed on a remote source operatively connected to the electrical device.

In another embodiment, the device performance module can perform the assessing one or more performance capabilities of the electrical device and the adjusting of the application when the application is installed on the electrical device or when the application is selected for download to the electrical device.

The assessing one or more performance capabilities of the electrical device can be application specific. In another implementation, the assessing one or more performance capabilities of the electrical device can be standardized.

In one embodiment, adjusting the application can include increasing or decreasing the complexity of the operation of the application. In another embodiment, adjusting the application can include enabling or disabling one or more aspects of the application. In a further embodiment, adjusting the application includes deleting a portion of the application.

In another respect, embodiments are directed to a method of tailoring applications for an electrical device. The method includes assessing one or more performance capabilities of the electrical device when an application is installed on or initiated for execution on the electrical device. The method also includes adjusting the application based on one or more of the assessed performance capabilities of the electrical device.

The assessing and adjusting can be performed at any suitable time. For instance, the assessing and/or adjusting can be performed when the application is initiated for execution on the electrical device. Alternatively, the assessing and/or adjusting can be performed when the application is installed on the electrical device or when the application is selected for download to the electrical device. The assessing can be application specific, or it can be standardized.

In one embodiment, the adjusting can include increasing or decreasing the complexity of the operation of the application. In another embodiment, the adjusting can include enabling or disabling one or more aspects of the application. In still another embodiment, the adjusting the application includes deleting a portion of the application.

In a further respect, embodiments are directed to an electrical device configured for communicative linking to an application repository storing one or more available applications. The electrical device includes a processor, memory operatively connected to the processor, a display and a device performance module stored on the memory.

The device performance module is configured to assess one or more performance capabilities of the electrical device. The device performance module is also configured to report the one or more assessed performance capabilities to an application repository. Further, responsive to receiving a list of suitable applications for the electrical device based on the one or more assessed performance capabilities from the application repository, the device performance module is configured to present at least a subset of suitable applications for the electrical device to a user on the display.

The device performance module can perform the assessing one or more performance capabilities of the electrical device at any suitable time. For instance, the device performance module can perform the assessing one or more performance capabilities of the electrical device when the electrical device accesses an application repository. The assessing one or more performance capabilities of the electrical device can be standardized. The reporting of the one or more assessed performance capabilities to the application repository can be performed automatically.

The at least a subset of suitable applications for the electrical device can include one or more applications that are fully enabled on the electrical device. The at least a subset of suitable applications for the electrical device can include one or more applications that are not currently supported on the electrical device with a recommendation for one or more additional actions to make each of such applications supported on the electrical device.

In a still further respect, embodiments are directed to a method of tailoring applications for an electrical device. The electrical device is configured for communicative linking to an application repository storing one or more available applications. The method includes assessing one or more performance capabilities of the electrical device. The method further includes reporting the one or more assessed performance capabilities to the application repository. Further, responsive to receiving a list of suitable applications for the electrical device based on the one or more assessed performance capabilities from the application repository, the method includes presenting at least a subset of suitable applications for the electrical device to a user.

Assessing one or more performance capabilities of the electrical device can be performed at any suitable time. For instance, assessing one or more performance capabilities of the electrical device can be performed when the electrical device accesses an application repository. Assessing one or more performance capabilities of the electrical device can be standardized.

Reporting the one or more assessed performance capabilities to the application repository can be performed at any suitable time. For example, reporting the one or more assessed performance capabilities to the application repository can be performed responsive to receiving a query from the application repository. Reporting the one or more assessed performance capabilities to the application repository can be performed automatically.

In one embodiment, the at least a subset of suitable applications for the electrical device can include one or more applications that are fully enabled on the electrical device. In another embodiment, the at least a subset of suitable applications for the electrical device can include one or more applications that are not currently supported on the electrical device with a recommendation for one or more additional actions to make the application supported on the electrical device.

In another respect, embodiments are directed to an application repository storing one or more available applications. The application repository includes a server having a processor. The processor can be configured to obtain one or more performance capabilities of an electrical device accessing the application repository. The processor can also be configured to, among the available applications, determine suitable applications for operation on the electrical device based on one or more of the obtained performance capabilities. Additionally, the processor can be configured to report the suitable applications to the electrical device. The suitable applications reported to the electrical device can include one or more applications that are not currently supported on the electrical device along with a recommendation for one or more additional actions to make the application supported on the electrical device. The processor can further be configured to query the electrical device accessing the application repository for one or more performance capabilities of the electrical device.

Obtaining one or more performance capabilities of an electrical device accessing the application repository can be performed at any suitable time. For instance, obtaining one or more performance capabilities of an electrical device accessing the application repository can be performed when the electrical device accesses the application repository. As another example, obtaining one or more performance capabilities of an electrical device accessing the application repository can be performed responsive to receiving a request to search the application repository.

Determining suitable applications for operation on the electrical device based on one or more of the obtained performance capabilities can be performed at any suitable time. For example, determining suitable applications for operation on the electrical device based on one or more of the obtained performance capabilities can be performed when the electrical device accesses the application repository. In one embodiment, determining suitable applications for operation on the electrical device based on one or more of the obtained performance capabilities can be performed responsive to receiving a request to search the application repository.

In yet another respect, embodiments are directed to a method of tailoring applications in an application repository to an electrical device accessing the application repository. The method includes obtaining one or more performance capabilities of the electrical device accessing the application repository. The method also includes determining applications stored in the application repository suitable for operation on the electrical device based on one or more of the obtained performance capabilities. The method further includes reporting the suitable applications to the electrical device. The method may additionally include querying the electrical device accessing the application repository for one or more performance capabilities of the electrical device.

Obtaining one or more performance capabilities of the electrical device accessing the application repository can be performed at any suitable time. For instance, obtaining one or more performance capabilities of the electrical device accessing the application repository can be performed when the electrical device accesses the application repository. In one embodiment, obtaining one or more performance capabilities of the electrical device accessing the application repository can be performed responsive to receiving a request to search the application repository.

Determining applications stored in the application repository suitable for operation on the electrical device based on one or more of the obtained performance capabilities can be performed at any suitable time. For example, determining applications stored in the application repository suitable for operation on the electrical device based on one or more of the obtained performance capabilities can be performed when the electrical device accesses the application repository. Alternatively, determining applications stored in the application repository suitable for operation on the electrical device based on one or more of the obtained performance capabilities can be performed responsive to receiving a request to search the application repository.

Reporting the suitable applications to the electrical device can include reporting one or more applications that are not currently supported on the electrical device with a recommendation for one or more additional actions to make the application supported on the electrical device.

### BRIEF DESCRIPTION OF THE DRAWINGS

FIG. 1 is an example of a system for tailoring an application and/or an application repository for an electrical device.

FIG. 2 is an example of a block diagram of an electrical device.

FIG. 3 is an example of a method of tailoring an application for an electrical device.

FIG. 4 is an example of a method for tailoring an application repository for an electrical device.

### DETAILED DESCRIPTION

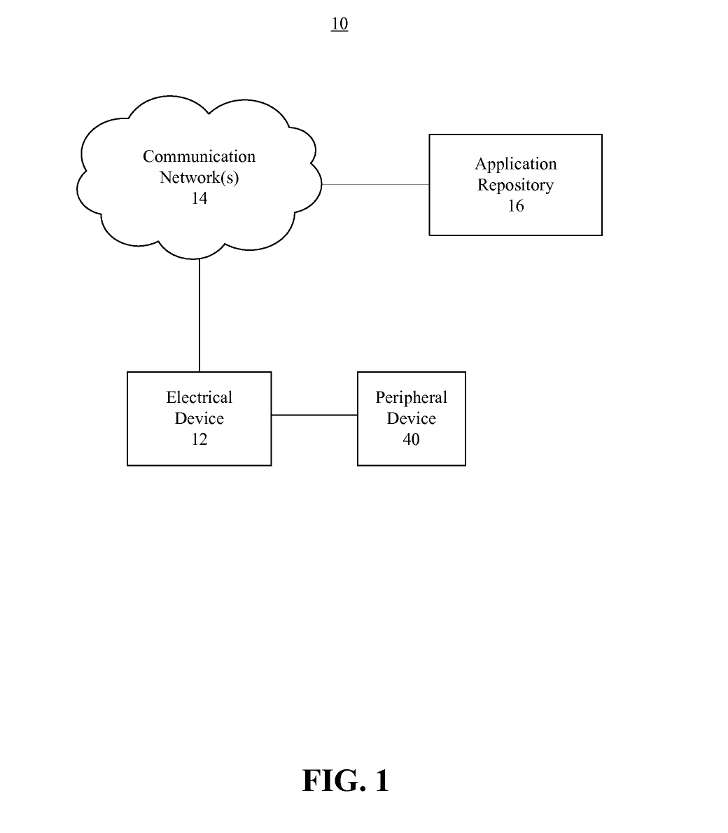

Arrangements described herein relate to systems and methods for tailoring applications and application repositories for electrical devices. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Arrangements are shown in FIGS. 1-4, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIG. 1, an exemplary system 10 for tailoring an application and/or an application repository for an electrical device is shown. The system 10 can include an electrical device 12 used by one or more users (e.g., persons). “Electrical device” means any device that is at least partially powered by electrical energy. The electrical device 12 can be configured to download, access, execute, store and/or display an application thereon. The electrical device 10 can be any suitable device including, for example, a cellular telephone, a smart phone, a personal digital assistant (“PDA”), a digital reader, a handheld device having wired and/or wireless connection capability, a computer (e.g., a laptop, tablet, desktop, etc.), a portable electrical device, a portable computing device, an entertainment device (e.g., a music or video device, TV set-top box, smart TV, connected TV, or a satellite radio), a global positioning system device, a digital audio player (e.g., MP3 player), an e-book reader, a camera or a game console. In some instances, the electrical device 10 can be configured to communicate via a wireless and/or wired medium. However, the electrical device 10 is not limited to devices with such capability, as the electrical device 10 may not be configured to communicate via a wireless or wired medium. Embodiments described herein can be implemented into any suitable electrical device, including any of those listed above. The electrical device 10 can include any suitable operating system

Again, the system 10 can include a communication network 14. “Communication network” is defined as one or more components designed to facilitate the delivery of information from one source to another. As an example, the communication network 16 can comprise the Internet, a wide area network (WAN), a local area network (LAN), wireless local area network (WLAN) transceiver, a personal area network (PAN), a wireless communication network, and/or the like. The communication network 14 can include wired communication links and/or wireless communication links.

The system 10 can include one or more application repositories 16, which can offer one or more applications for download to, access by and/or execution on the electrical device 12. An “application repository” is defined as a medium for storing one or more applications available for download to, access by and/or execution on a computing device. An “application” is defined as software that, when installed on, accessed by, executed by and/or displayed on a machine, enables a user to perform one or more specified tasks. The application can be for any purpose, including, reference, business, entertainment, education, and communication, just to name a few possibilities.

The application repository 16 can be a server, computer or other suitable computing device that includes a processor (not shown), memory (not shown), a computer-readable storage medium (not shown), a network adapter (not shown), and other components known to those skilled in the art. The electrical device 12 can be communicatively coupled to the application repository 16 in any suitable manner, such as by the communication network 14. “Communicatively linked” can include direct or indirect connections through a communication channel or pathway or another component or system.

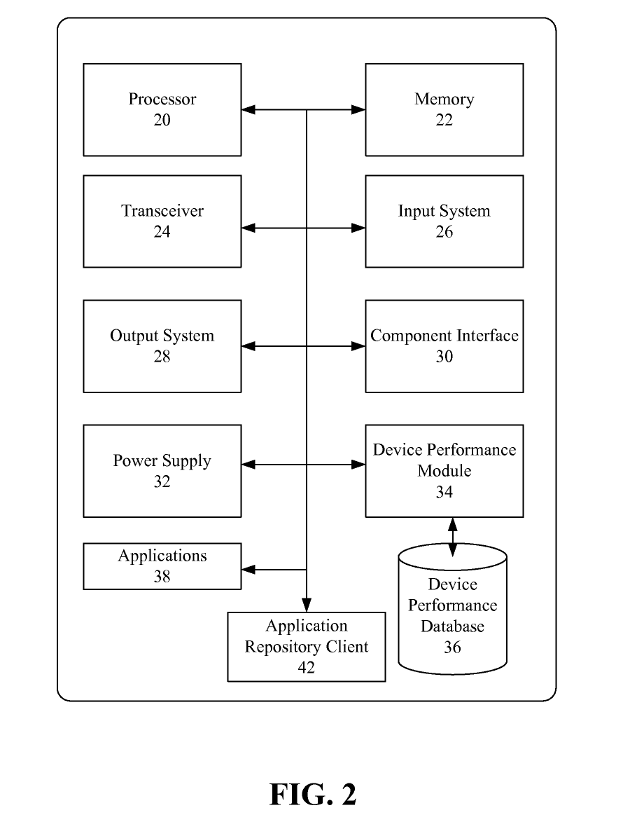

FIG. 2 shows an example of a block diagram of the electrical device 12. Some of the various possible elements of the exemplary electrical device 12 shown in FIG. 2 will now be described. It will be understood that it is not necessary for an electrical device 12 to have all of the elements shown in FIG. 2 or described herein. The electrical device 12 can have any combination of the various elements shown in FIG. 2. Further, the electrical device 12 can include additional elements that are not shown in FIG. 2, as one skilled in the art will appreciate.

The electrical device 12 can include a processor 20. “Processor” means any component or group of components that are configured to execute any of the processes described herein. The processor 20 may be implemented with one or more general-purpose and/or special-purpose processors. Examples of suitable processors 20 include microprocessors, microcontrollers, DSP processors, and other circuitry that can execute software.

The electrical device 12 can include memory 22 for storing various types of data. The memory 22 can include volatile and/or non-volatile memory. Examples of suitable memory 22 may include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The memory 22 can be operatively connected to the processor 20 for use thereby. The term “operatively connected,” as used throughout this description, can include direct or indirect connections, including connections without direct physical contact.

The electrical device 12 can further include one or more transceivers 24. The transceiver 24 can be operatively connected to the processor 20 and/or the memory 22. Any suitable transceiver can be used to access a network, access point, node or other electrical device for the transmission and receipt of data. The transceiver 24 may be a wireless transceiver using any one of a number of wireless technologies. Examples of suitable transceivers include a cellular transceiver, broadband Internet transceiver, local area network (LAN) transceiver, wide area network (WAN) transceiver, wireless local area network (WLAN) transceiver, personal area network (PAN) transceiver, body area network (BAN) transceiver, WiFi transceiver, WiMax transceiver, Bluetooth transceiver, 3G transceiver, 4G transceiver, ZigBee transceiver, WirelessHART transceiver, MiWi transceiver, IEEE 802.11 transceiver, IEEE 802.15.4 transceiver, or a Near Field Communication (NFC) transceiver, just to name a few possibilities. The transceiver 24 can include any wireless technology developed in the future. Again, the transceiver 24 can include one or more transceivers and can be any suitable combination of transceivers, including any combination of the transceivers noted above.

The electrical device 12 can include an input system 26 for receiving input from a user. Any suitable input system 32 can be used, including, for example, a keypad, display, touch screen, multi-touch screen, button, joystick, mouse, trackball, microphone or combinations thereof. The electrical device 12 can include an output system 28 for presenting information to the user. The output system 28 can include a display, a microphone, earphone and/or speaker. Some components of the electrical device 12 may serve as both a component of the input system 26 and a component of the output system 28.

The electrical device 12 may include a component interface 30. Additional elements can be operatively connected to the component interface 30, including, for example, a universal serial bus (USB) or other interface. The electrical device 12 may include a power supply 32. As is shown in FIG. 2, the processor 20, the memory 22, the transceiver 24, the input system 26, the output system 28, the component interface 30 and/or the power supply 32 can be operatively connected to each other in any suitable manner.

The electrical device 12 can be adapted to assess one or more performance capabilities of an electrical device. “Assess” means collect, test, measure, determine, identify and/or quantify one or more performance capabilities of the electrical device. “Performance capabilities” means any characteristic that relates to and/or affects the operation of the electrical device. The electrical device 12 can include a device performance module 34. The device performance module 34 is any device, component, system or means that can assess one or more performance capabilities of an electrical device. For instance, the device performance module 34 can include any suitable software and/or hardware for assessing device performance. The device performance module 34 can be operatively connected to one or more of the elements of the electrical device 12, including any of those mentioned herein. In the case of software, the device performance module 34 can be stored in any suitable medium on the device, such as in the memory 22.

The device performance module 34 can assess any suitable performance capability of the electrical device 12. For instance, the device performance module 34 can assess the general execution rate of the electrical device 12. The device performance module 34 can assess the speed of the processor 20 of the electrical device 12. Alternatively or in addition, the device performance module 34 can assess the graphics capabilities of the electrical device 12. For instance, the device performance module can assess whether the electrical device 12 is enabled for transparency blitting and/or the rate at which the electrical device 12 can perform transparency blitting. Again, these are just a few examples of device performance capabilities that the device performance module 34 may assess.

Additional examples of performance capabilities that the device performance module 34 can assess can include: read and/or write times to/from memory, the capabilities of the graphics processing unit, the capabilities of other device hardware (e.g. one or more components of the input system, one or more components of the output system, etc.), the version of the operating system or other software installed on the electrical device, availability, response time, channel capacity, latency, completion time, service time, bandwidth, throughput, relative efficiency, scalability, performance per watt, compression ratio, instruction path length and speed up. A further example of a performance capability that the device performance module 34 can assess can be the memory capacity of the electrical device. Still another example of a performance capability that the device performance module 34 can assess can be the availability of features on the electrical device 12 (e.g., an accelerometer, a video camera, etc.). Yet another example of a performance capability that the device performance module 34 can assess can be the type of wireless communication supported by the electrical device 12 (e.g., cellular, Wi-Fi, Bluetooth, etc.)

The assessing of the one or more performance capabilities of the electrical device can be standardized. “Standardized” means that the assessing is done with respect to a predetermined set of one or more performance capabilities for any application that is installed or initiated on the electrical device 12. In such case, the same assessment of the performance capabilities of the electrical device is performed for each application installed or initiated on the electrical device. The predetermined set of one or more performance capabilities can be set by the user or some other entity.

Alternatively, the assessing of the one or more performance capabilities of the electrical device can be application specific. “Application specific” means that the assessment of the one or more performance capabilities is done based on the particular application being installed or initiated. In such case, the one or more performance capabilities that are assessed with respect to the initiation or installation of a first application may or may not be the same as the one or more performance capabilities that are assessed with respect to the initiation or installation of a second application. In such case, the one or more performance capabilities that are assessed for each application can be set by the user or some other entity.

The device performance module 34 can include and/or have access to a device performance database 36. The device performance database 36 can store information relating to one or more performance capabilities of an electrical device as tested, measured, determined and/or quantified by the performance module 34. The performance capability information can be provided in any suitable format. The device performance database 36 can be located on the electrical device 12, such as in memory 22, or it can be located in a source external to the electrical device 12.

There can be one or more applications 38 installed on the electrical device 12, such as in memory 22 or on some other suitable unit that the electrical device 12 can access. At least one of the applications 38 on the electrical device 12 can be configured to query the device performance information from the device performance module 34 and/or the device performance database 36. Based on the performance information obtained, the applications 39 can be configured to adjust their execution for the electrical device 12.

In some instances, one or more applications can be stored in a remote source. A “remote source” means that the one or more applications are not stored on the electrical device. For example, the electrical device 12 itself may not be able to download, install, access, execute and/or store applications. In such cases, a peripheral device 40 can be operatively connected to the electrical device 12. The peripheral device 40 can be configured to download, access, execute and/or store applications. In one embodiment, the peripheral device 40 can be an external hard drive, a portable memory device, a set-top box or set-top unit, a disc player or a game console. The peripheral device 40 can be any device that can operatively connect to a electrical device 12 to provide applications thereto. The electrical device 12 can access and/or execute application software resident on the peripheral device 40.

Another example of a remote source is the application repository or some other network component. The applications can be accessed from the remote source by the electrical device 12 and/or the peripheral device 36. The application software may be executed on the remote source, the electrical device 12 and/or the peripheral device 40. It is important to note that, even if the electrical device 12 is configured to download, install, access, execute and/or store applications, the applications may nonetheless be stored in a remote source. Such an arrangement is relevant to virtual applications, which appear local to the electrical device 12 but are stored remotely.

The electrical device 12 can be configured to listen for, authenticate and/or process commands, information and/or data from one or more application repositories (e.g., application repository 16). Such functionality can be implemented with hardware, software and combinations of hardware and software. In one embodiment, the electrical devices 12 can include an application repository client 42 instantiated thereon. The application repository client 42 can be implemented as computer-readable code that, when executed by the processor, implement at least some of the various processes described herein. The term “client” means client-side software instantiated on the electrical device 12 that establishes a communication link with an application repository or some other component. The application repository client 42 can be included in the device performance module 34.

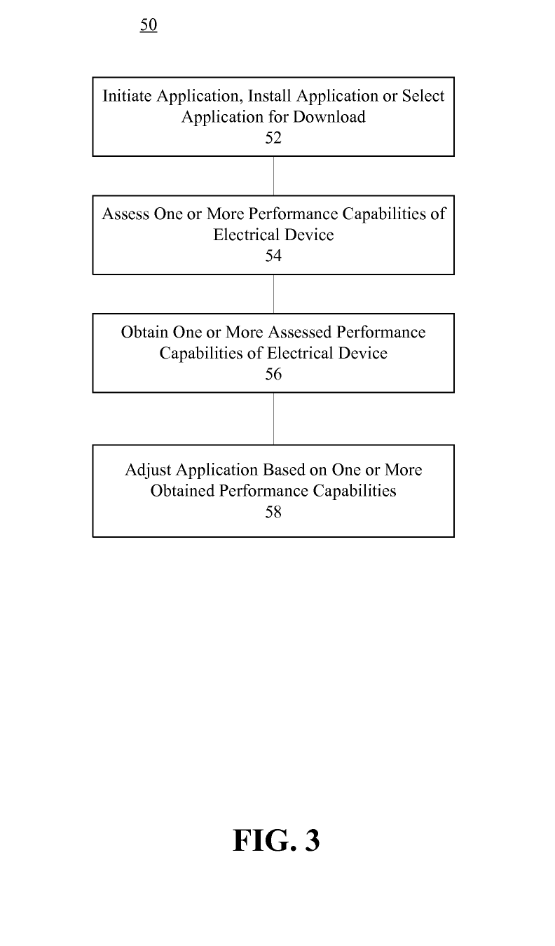

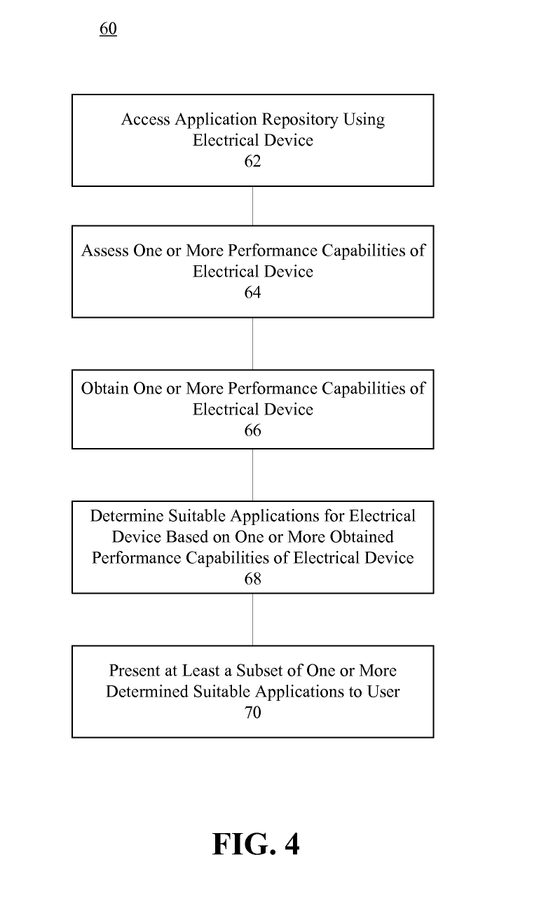

Now that the various components of the electrical device 10 and associated systems have been described, examples of various manners of tailoring application for the electrical device 12 and/or systems will now be presented. Various possible steps of such methods will now be described. The methods illustrated in FIGS. 3-4 may be applicable to the embodiments described above in relation to FIGS. 1-2, but it is understood that the methods can be carried out with other suitable systems and arrangements. Moreover, the methods may include other steps that are not shown here, and in fact, the methods are not limited to including every step shown. The steps that are illustrated here as part of the methods are not limited to this particular chronological order, either. Indeed, some of the steps may be performed in a different order than what is shown and/or at least some of the steps shown can occur simultaneously.

Referring to FIG. 3, an example of a method 50 of tailoring applications for an electrical device is shown. At step 52, an application can be installed on the electrical device 12, the application can be initiated for execution and/or output on the electrical device, or an application can be selected for download on the electrical device 12.

At step 54, one or more performance capabilities of the electrical device can be assessed. The information regarding the assessed performance capabilities can be stored in any suitable manner, such as in the device performance database 36, memory 22 and/or other suitable location. It should be noted that the step of assessing one or more performance capabilities can be performed before an application is installed, executed or even selected for download on the electrical device 12. That is, step 54 may occur before, during or after step 52.

The assessing can be performed in any suitable manner. In one embodiment, the assessing can be performed by the device performance module 34. Further, the assessing can be performed on any suitable basis. For instance, the assessing can be performed continuously, periodically according to a predetermined interval and/or even randomly. Alternatively or in addition, the assessing can be performed automatically in response to the installation and/or initiation of an application.

At step 56, one or more of the assessed performance capabilities of the electrical device can be obtained. For instance, the device performance module 34 can obtain the assessed performance capabilities from the device performance database 36, memory 22 and/or other suitable location. The obtaining of the assessed performance capabilities can occur at any suitable time. For instance, the obtaining can be performed at runtime of an application. Alternatively, the obtaining can be performed when an application is installed. The obtaining can occur immediately once the performance capabilities are assessed.

At decision block 58, one or more aspects of the initiated or installed application can be adjusted based on the one or more of the assessed performance capabilities for optimal performance on the electrical device. As used herein, “adjusting an application based on one or more of the assessed performance capabilities of the electrical device” means that one or more aspects of the application are activated, deactivated (including total disablement of the application), enabled, disabled, deleted, removed, trimmed and/or modified. The adjusting can be performed automatically, or the user can be prompted to approve of the adjusting. The application can be adjusted in any suitable manner. For instance, if the electrical device is a relatively slowly performing device, then the complexity of the operation of the application can be reduced. Alternatively, if the electrical device is a relatively fast performing device (e.g., the electrical device has a faster processor), then the complexity of the operation of the application can remain the same or can even be increased. That is, an application can be built or programmed with different levels of functionality, and these levels can be activated, deactivated, enabled, disabled, deleted, removed, modified and/or trimmed based on one or more performance capabilities of the electrical device 12.

Further, certain features and/or elements of the application can be enabled or disabled based on the one or more obtained performance capabilities. As an example, a global positioning system (GPS) feature of an application may be enabled or disabled based on the performance capabilities of the electrical device. Further, multi-threading may or may not be enable or disabled based on the performance capabilities of the electrical device. As another example, the output of the electrical device can be two dimensional or three dimensional based on the performance capabilities of a graphics processing unit of the electrical device. If the electrical device includes a better performing graphics processing unit, then three dimensional output can be enabled. However, if the electrical device includes a lower performing graphics processing unit, then a two dimensional version can be initiated and/or installed on the electrical device.

Yet another example of the adjusting can be the amount of information displayed on the electrical device. The amount of information can be increased or decreased depending on the obtained performance capabilities. For instance, if an electrical device includes a display and/or graphics processing unit that can support a relatively high level of pixel density, then the application can be configured to display its output at a higher resolution. Alternatively, if the pixel density of the display and/or graphics processing unit do not support relatively high levels of pixel density, then the application can be configured to display its output at a lower resolution. As a further example, the amount of data that is presented on the display of or otherwise by of the electrical device can be increased or decreased by depending on the obtained performance capabilities of the electrical device.

Still another example of the adjusting is the complexity of a user interface of the application. For instance, the resolution of the user interface and/or the quantity of features presented by the user interface can be increased or decreased depending on the performance capabilities. Further, certain levels of an application (e.g. a game) can be enabled or disabled depending on the obtained performance capabilities of the electrical device. As a further example, the amount of data that is accessed by the electrical device can be adjusted based on the read/write times from memory of the electrical device. In still another example, the components of the application that are installed on the electrical device can be adjusted based on performance capabilities of the electrical device. One or more features can be deactivated or deleted from an application if such features would not be supported by the electrical device. For instance, if an application has a video conferencing feature, such feature can be deactivated or deleted from the application if the electrical device does not support such functionality.

Referring to FIG. 4, an example of a method 60 of tailoring applications for an electrical device is shown. At step 62, an application repository can be accessed by an electrical device. At step 64, one or more performance capabilities of the electrical device can be assessed. The information regarding the assessed performance capabilities can be stored in any suitable manner, such as in the device performance database 36, memory 22 and/or other suitable location.

The assessing can be performed in any suitable manner. In one embodiment, the assessing can be performed by the device performance module 34. Further, the assessing can be performed on any suitable basis. For instance, the assessing can be performed continuously, periodically according to a predetermined interval and/or even randomly. Alternatively or in addition, the assessing can be performed when an application repository is accessed. For instance, the assessing may be performed automatically in response to accessing an application repository. In one implementation, the assessing can be performed upon receiving a user input. As an example, the user input can be a command input on the electrical device, or it can be a search conducted in the application repository.

At step 66, one or more performance capabilities of the electrical device can be obtained. It will be noted that the obtaining of the performance capabilities may be performed in any suitable manner. For instance, the one or more performance capabilities can be obtained by the accessed application repository. In such case, the application repository may query the electrical device. Alternatively, the one or more performance capabilities can be reported to the accessed application repository by the electrical device, such as by the application repository client 42. Such reporting may be performed automatically by the electrical device at any suitable point, such as when the electrical device accesses the application repository or responsive to receiving a query from the application repository.

At step 68, one or more of the suitable applications in the application repository can be determined as being suitable for execution and/or output on the electrical device based on the one or more obtained performance capabilities of the electrical device. Such a determination can be performed by, for example, the application repository 16, which can filter the available applications for those that are suitable for the electrical device based on the device's performance capabilities.

The suitable applications for the electrical device can be determined in any suitable manner. For instance, the applications in which all features are enabled can be determined. Further, the applications that would be less than fully enabled on the particular electrical device can be determined. More particularly, the applications in which certain features are disabled for the particular electrical device can be determined and/or the applications that will not work on the electrical device can be determined. The application repository 16 can report the determined applications to the electrical device 12, such as to the application repository client 42 on the electrical device 12. The reporting of the determined applications can be provided in any suitable form, such as a list. The reported applications may exclude applications that will not operate on the electrical device 12.

The application repository 16 includes an application that would not normally be supported on the electrical device 12 based on the one or more obtained performance capabilities of the electrical device 12, the application repository 16 can make recommendations to allow the application to become supported on the electrical device 12. Such recommendations can include hardware recommendations and/or software recommendations for the electrical device 12, including additions, modifications and/or deletions. For instance, the application repository 16 can recommend a software patch be downloaded to allow one or more applications to become supported on the electrical device. The application repository 16 can provide instructions for how to obtain the software patch, such as by proving a hyperlink. As another example, the application repository 16 can recommend that if additional memory is added to the electrical device, then one or more applications would become supported on the electrical device 12. The application repository 16 can also recommend the deletion or deactivation of a portion of an application to make it become supported on the electrical device 12. Again, these are just a few examples of possible recommendations that the application repository 16 can make.

At step 70, at least a subset of the one or more determined suitable applications can be presented to the user of the electrical device 12. “At least a subset” means one or more. The subset of the one or more determined suitable applications can include one or more applications that are not currently supported on the electrical device but would become supported if additional steps or actions are taken. At least a subset of the one or more determined suitable application can be presented on a display of the electrical device 12. In addition to presenting the suitable applications, the particular adjustments to an application that may need to be made to enhance the performance of the application on the electrical device may be presented.

If a user downloads an application from the application repository, then one or more aspects of the application can be adjusted, if necessary, when the application is installed. For instance, if it is determined that the operation of an application is optimal on the electrical device if the application includes certain components, then such components can be installed on the electrical device. Alternatively or in addition, an application from the application repository can be installed on the device. However, an adjustment of one or more aspects of the application can occur when a user initiates the application on the device.

It will be appreciated that systems and methods described herein can provide numerous benefits. For instance, applications that a user initiates and/or installs on an electrical device can be tailored for the particular electrical device based on its performance capabilities. Thus, the operation of the application can be optimized for the end user. Further, a user's experience with an application repository can be enhanced, as the application repository can present to the user those applications that are suitable for the user's particular device. As a result, the user will not be presented with applications that may be less than optimal for the user's device, thereby saving a user time, avoiding frustration and potentially enhancing the user's enjoyment of the electrical device. Further, embodiments herein can be facilitated by having one or more applications installed on an electrical device that can perform at least the assessing of the electrical device's performance capabilities. For example, there can be a single application installed on the electrical device for such purposes.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Aspects herein can be embodied in other forms without departing from the spirit or essential attributes thereof. Accordingly, reference should be made to the following claims, rather than to the foregoing specification, as indicating the scope of the invention.

What is claimed is:

1. An electrical device comprising:
a processor;
memory operatively connected to the processor; and
a device performance module stored on the memory, the device performance module being configured to:
assess one or more performance capabilities of the electrical device; and
adjust an application based on one or more of the assessed performance capabilities of the electrical device.

2. The electrical device of claim 1, wherein the device performance module performs the assessing one or more performance capabilities of the electrical device and the adjusting of the application when the application is initiated for execution on the electrical device.

3. The electrical device of claim 2, wherein the application is installed on the electrical device.

4. The electrical device of claim 2, wherein the application is installed on a remote source operatively connected to the electrical device.

5. The electrical device of claim 1, wherein the device performance module performs the assessing one or more performance capabilities of the electrical device and the adjusting of the application when the application is installed on the electrical device or when the application is selected for download to the electrical device.

6. The electrical device of claim 1, wherein assessing one or more performance capabilities of the electrical device is application specific.

7. The electrical device of claim 1, wherein assessing one or more performance capabilities of the electrical device is standardized.

8. The electrical device of claim 1, wherein adjusting the application includes increasing or decreasing the complexity of the operation of the application.

9. The electrical device of claim 1, wherein adjusting the application includes enabling or disabling one or more aspects of the application.

10. The electrical device of claim 1, wherein adjusting the application includes deleting a portion of the application.

11. A method of tailoring applications for an electrical device, the method comprising:
assessing one or more performance capabilities of the electrical device when an application is installed on or initiated for execution on the electrical device; and
adjusting the application based on one or more of the assessed performance capabilities of the electrical device.

12. The method of claim 11, wherein the assessing and adjusting are performed when the application is initiated for execution on the electrical device.

13. The method of claim 11, wherein the assessing and adjusting are performed when the application is installed on the electrical device or when the application is selected for download to the electrical device.

14. The method of claim 11, wherein the assessing is application specific.

15. The method of claim 11, wherein the assessing is standardized.

16. The method of claim 11, wherein adjusting includes increasing or decreasing the complexity of the operation of the application.

17. The method of claim 11, wherein adjusting includes enabling or disabling one or more aspects of the application.

18. The method of claim 11, wherein adjusting the application includes deleting a portion of the application.

19. An electrical device configured for communicative linking to an application repository storing one or more available applications, the electrical device comprising:
a processor;
memory operatively connected to the processor;
a display; and
a device performance module stored on the memory, the device performance module being configured to:
assess one or more performance capabilities of the electrical device; and
report the one or more assessed performance capabilities to an application repository; and
responsive to receiving a list of suitable applications for the electrical device based on the one or more assessed performance capabilities from the application repository, present at least a subset of suitable applications for the electrical device to a user on the display.

20. The electrical device of claim 19, wherein the device performance module performs the assessing one or more performance capabilities of the electrical device when the electrical device accesses an application repository.

21. The electrical device of claim 19, wherein assessing one or more performance capabilities of the electrical device is standardized.

22. The electrical device of claim 19, wherein the at least a subset of suitable applications for the electrical device includes applications that are fully enabled on the electrical device.

23. The electrical device of claim 19, wherein the at least a subset of suitable applications for the electrical device includes one or more applications that are not currently supported on the electrical device with a recommendation for one or more additional actions to make the application supported on the electrical device.

24. A method of tailoring applications for an electrical device, the electrical device being configured for communicative linking to an application repository storing one or more available applications, the method comprising:
assessing one or more performance capabilities of the electrical device;
reporting the one or more assessed performance capabilities to the application repository; and
responsive to receiving a list of suitable applications for the electrical device based on the one or more assessed performance capabilities from the application repository, presenting at least a subset of suitable applications for the electrical device to a user.

25. The method of claim 24, wherein assessing one or more performance capabilities of the electrical device is performed when the electrical device accesses an application repository.

26. The method of claim 24, wherein the reporting is performed responsive to receiving a query from the application repository.

27. The method of claim 24, wherein assessing one or more performance capabilities of the electrical device is standardized.

28. The method of claim 24, wherein the at least a subset of suitable applications for the electrical device includes applications that are fully enabled on the electrical device.

29. The method of claim 24, wherein the at least a subset of suitable applications for the electrical device includes one or more applications that are not currently supported on the electrical device with a recommendation for one or more additional actions to make the application supported on the electrical device.

30. An application repository storing one or more available applications, the application repository comprising:
a server having a processor configured to:
obtain one or more performance capabilities of an electrical device accessing the application repository;
among the available applications, determine suitable applications for operation on the electrical device based on one or more of the obtained performance capabilities; and
report the suitable applications to the electrical device.

31. The application repository of claim 30, wherein the processor is further configured to:
query the electrical device accessing the application repository for one or more performance capabilities of the electrical device.

32. The application repository of claim 30, wherein obtaining one or more performance capabilities of an electrical device accessing the application repository is performed when the electrical device accesses the application repository.

33. The application repository of claim 30, wherein obtaining one or more performance capabilities of an electrical device accessing the application repository is performed responsive to receiving a request to search the application repository.

34. The application repository of claim 30, wherein determining suitable applications for operation on the electrical device based on one or more of the obtained performance capabilities is performed when the electrical device accesses the application repository.

35. The application repository of claim 30, wherein determining suitable applications for operation on the electrical device based on one or more of the obtained performance capabilities is performed responsive to receiving a request to search the application repository.

36. The application repository of claim 30, wherein the suitable applications reported to the electrical device include one or more applications that are not currently supported on the electrical device with a recommendation for one or more additional actions to make the application supported on the electrical device.

37. A method of tailoring applications in an application repository to an electrical device accessing the application repository comprising:
obtaining one or more performance capabilities of the electrical device accessing the application repository;
determining applications stored in the application repository suitable for operation on the electrical device based on one or more of the obtained performance capabilities; and
reporting the suitable applications to the electrical device.

38. The method of claim 37, further including:
querying the electrical device accessing the application repository for one or more performance capabilities of the electrical device.

39. The method of claim 37, wherein obtaining one or more performance capabilities of the electrical device accessing the application repository is performed when the electrical device accesses the application repository.

40. The method of claim 37, wherein obtaining one or more performance capabilities of the electrical device accessing the application repository is performed responsive to receiving a request to search the application repository.

41. The method of claim 37, wherein determining applications stored in the application repository suitable for operation on the electrical device based on one or more of the obtained performance capabilities is performed when the electrical device accesses the application repository.

42. The method of claim 37, wherein determining applications stored in the application repository suitable for operation on the electrical device based on one or more of the obtained performance capabilities is performed responsive to receiving a request to search the application repository.

43. The method of claim 37, wherein reporting the suitable applications to the electrical device includes reporting one or more applications that are not currently supported on the electrical device with a recommendation for one or more additional actions to make the application supported on the electrical device.
